(19) United States
(12) Patent Application Publication
(10) Pub. No.: US 2009/0078110 A1
(43) Pub. Date: Mar. 26, 2009

(54) Pneumatic drive system

(76) Inventors: Dieter Waldmann, Ebersbach (DE); Jan-Peter Bender, Denkendorf (DE); Jose Arana, Esslingen (DE)

Correspondence Address: Steven T. Zuschlag;Hoffman & Baron, 6900 Jericho Turnpike, Syosset, NY, 11791, US

(21) Appl. No.: 11/918,817

(22) PCT Filed: Jan. 18, 2007
(86) PCT No.: PCT/EP2007/000398

§ 371 Date: Oct. 18, 2007

(30) Foreign Application Priority Data
Feb. 21, 2006 (DE) 20 2006 002 727.0

(51) Int. Cl. F15B 13/042

(52) U.S. Cl. 91/403

(57) ABSTRACT

It is a question of a pneumatic drive system comprising at least one pneumatic drive (2) possessing a drive housing (4) and an output drive unit (6) able to be shifted in relation to it by the action of compressed air, the output drive unit (6) including an output drive piston (8), which in the drive housing (4) separates two working chambers (12 and 13) from one another, one or both of such chambers being connected with a pneumatic control line (17 and 18), such line having control valve means (22 and 23) able to be switched over between an air economy position and an open position (24) making available a flow cross section which is larger than that of the air economy position, such control valve means being provided with actuating means (32) able to be activated in a manner dependent on the position of the output drive unit (6), such actuating means being able to cause a switching over of the control valve means (22 and 23) into the air economy position, when the output drive unit (6), owing to the compressed air flowing through the control valve means (22 and 23) into the pneumatic drive (2), has reached an end of stroke position or a position just short thereof. The air economy setting has the particular feature that it is in the form of a choking setting (25) opening up a flow cross section which is smaller than in the open position (24).

The invention relates to a pneumatic drive system comprising at least one pneumatic drive possessing a drive housing and an output drive unit able to be shifted in relation to it by the action of compressed air, the drive unit including a output drive piston, which in the drive housing separates two working chambers from one another, one or both of such chambers being connected with a pneumatic control line, such line having control valve means able to be switched over between an air economy position and an open position making available a flow cross section which is larger than that of the air economy position, such control valve means being provided with actuating means able to be activated in a manner dependent on the position of the output drive unit, such actuating means being able to cause a switching over of the control valve means into the air economy position, when the output drive unit, owing to the compressed air flowing through the control valve means into the pneumatic drive, has reached an end of stroke position or a position just short thereof.

A pneumatic drive system disclosed in the European patent publication EP 0771396 B1 of this type comprises a pneumatic drive designed in the form of a crust breaker cylinder, which in the normal position of use is vertically aligned and which comprises a drive unit able to be lowered or raised by controlled actuation with compressed air, the purpose of such unit being to plunge into an aluminum meltin accordance with a predetermined cycle and to break up any crust of material formed on the surface thereof. The direction of motion of the output drive unit is predetermined by a direction setting valve. On the control duct connected with the bottom working chamber of the pneumatic cylinder there are control valve means constituted by a plunger valve, are able to be switched between an open position for maximum flow rate and an air economy position completely shutting off the air flow. During most of the movement of the output drive unit the control valve means are the open position so that a large setting force must be provided. Shortly before reaching the fully retracted end of stroke position the output drive unit however switches the control valve means into the air economy position so that no further compressed air can flow in. This prevents excessive filling of the associated working chamber and involves an economy in air use. When there is a drop in pressure in the captive air volume owing to a system dependent leak, the output drive unit will move downward under its own weight until the control valve means switch back into the open position so that compressed air will be pumped in to take its place and the output drive unit will be shifted again into the retracted end of stroke position.

Despite the advantages of this measure for economy in air there is nevertheless the disadvantage in conjunction with the pumping of compressed air to replenish the frequent opening and closing of the control valve means involves substantial wear. Furthermore, the resetting motion of the output drive unit due to cyclical pumping for replenishment will cause vibrations and thus cause interference with the proper operation of the pneumatic drive system and the plant fitted with it or may even cause damage.

The same set of problems also occur with the pneumatic drive system described in the patent publication WO 02/14698 A1. This system differs from the above mentioned one essentially in that the open position is in the form of a choked setting in order to reduce the filling intensity of the pneumatic drive in favor of a still further reduced air requirement. On reaching the end of stroke position of the output drive unit the control valve means are switched back into a close position.

The German patent publication DE 10 2004 029 990 A1 describes a pneumatic cylinder with end of stroke damping, the piston shutting off an outlet duct on reaching its end of stroke position so that the fluid can only flow by way of one choke duct. In the case of the German patent publication DE 101 38 026 C2 a choke is employed which is effective as regards the supplied fluid in order to build up an opposing pressure for retarding a piston.

One object of the present invention is to provide a pneumatic drive system of the type initially mentioned which in operation is subject to less mechanical loading.

In order to achieve this object the control valve means is so designed that the air economy position is a choke setting defining a flow cross section which is smaller than in the open position.

In contradistinction to the prior art the air economy setting is accordingly now not in the form of a closed setting completely shutting off the flow of air, but rather a choke setting which continues to permit a flow of air which is however reduced as compared with the open position. An economy in air requirement is then admittedly not possible to the same degree as with the initially discussed prior art. However since the flow rate is reduced in comparison with the open position, the pressure obtaining in the working chamber only increases slowly so that more particularly in the case of short working stroke times an increase in the working chamber pressure may be reduced to the power supply pressure or, respectively, the operating pressure. The particular advantage of the design in accordance with the invention does however lie in the at least substantial prevention of oscillating movements of the drive unit in relation to the drive housing in the end of stroke positions. Owing to the continuous replenishing flow of air into the working chamber the output drive unit may be reliably held in its end of stroke position so that frequent switching over of the control valve means and the resulting wear does not take place and furthermore continually occurring, troublesome vibration in the pneumatic drive may be substantially avoided.

More particularly there is the possibility of so designing the control valve means that the flow cross section in the choked position is of such a size that taking into account the initially mentioned air pressure on the inlet side at the control valve means the result is a flow, which lies within the range of the leak flow occurring in the system section arranged downstream from the control valve means. The resulting flow rate should preferably be equal to at least the leak flow. Accordingly the output drive unit is reliably held without an excessive pressure increase in the supplied working chamber.

It is more particularly conventional to have such a design that the set flow rate lies in the range of the design-dependent permissible leak flow. As long as then the leak rate occurring for example between the output drive unit and the drive housing or at the fluid duct connection points is in the permissible range, it will be continuously compensated and the retracted output drive unit will remain set in its end of stroke position. It is only when the leak rate occurring in the system exceeds the permissible value that owing to the insufficient replenishment with air, the initially mentioned position instability of the output drive unit occurs, something which is in practice the same as an advantageous indication of wear, because on the basis of any reciprocating movement occurring adjacent to the end of stroke position, of the output drive unit it is possible to conclude that one or more of the components of the drive system has exceeded its permissible wear limit and must be replaced.

Further advantageous developments of the invention are defined in the dependent claims.

The measures in accordance with the invention may be more particularly employed in the case of a linear drive as a pneumatic drive. However they may be adopted for example as well in the case of rotary drives or semi-rotary drives.

In the case of the pneumatic drive designed in the form of a linear drive it is preferably a question of a pneumatic cylinder, whose output drive unit possesses a piston extending out from the drive housing. In the case of an advantageous design in the form of a crust breaking cylinder the piston may be provided at one end with a plunger element, which is more particularly suitable for stabbing through the crust on an aluminum melt.

Dependent on the field of use the control valve means of the type described may be provided on both control lines or on only one control line. Accordingly there will be the effect explained above in the case of both or only one end of stroke position of the output drive unit.

In any case it is an advantage if the control valve means are placed downstream from a direction presetting valve on the inlet side, which is connected, or able to be connected, with the pressure medium source from the operating pressure and by the intermediary of whose switching position the stroke direction of the output drive unit may be set. In the case of such direction setting valve it will more particularly be a question of a 5/2 way valve.

A particularly compact arrangement is produced if at least the control valve means and the pneumatic drive are collected together as a single assembly unit. Any direction setting valve present may also be a component of such assembly unit.

The actuating means associated with the control valve means will preferably be response means arranged directly on or in the drive housing, which at or as from a certain position of the output drive unit respond to the same and cause the switching over of the control valve means from the open position into the choked position. In this case the response means will preferably include purely mechanical control valve means or control valve means also adapted for electrical operation. Mechanical response means will conveniently comprise at least one slidingly mounted plunger member extending into the path of motion of the output drive unit.

In order to particularly render possible use with different operating pressure it is an advantage if the control valve means comprise adjustment means, rendering possible an adjustable setting of the flow cross section made available in the choked position. Accordingly the flow rate occurring in the choked setting may be adjusted to suit requirements.

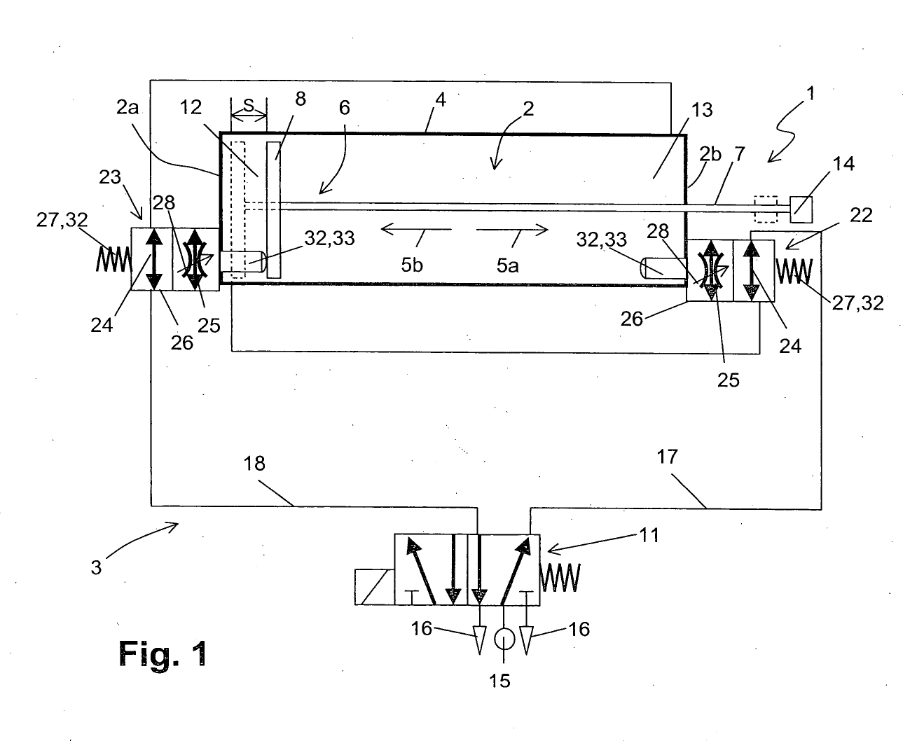

In the following the invention will be described on the basis of the accompanying drawing. The single FIGURE (FIG. 1) shows a circuit diagram of a pneumatic drive system adapted in a particularly advantageous manner.

The pneumatic drive system generally referenced 1 comprises a pneumatic drive 2 preferably in the form of a linear drive and a control means generally referenced 3 for controlling the manner of operation thereof. These components may if necessary be collected together as a compact assembly unit.

The pneumatic drive 2 includes a housing termed the drive housing 4 and having an elongated configuration, and furthermore a movable output drive unit 6 for performing working linear movements 5a and 5b in opposite directions.

Preferably the pneumatic drive 2 is designed in the form of a pneumatic cylinder fitted with a piston rod 7. The piston rod 7 is a component of the output drive unit 6 and is at one end secured to a output drive piston arranged for sliding motion in the interior of the drive housing 4.

The outlet drive piston 8 divides up the internal space of the drive housing 4 into a rear first working chamber 12 and a front second working chamber 13, through which the piston rod 7 extends in a sliding manner. The end section, protruding from the drive housing 4, of the piston rod 7 serves as a force or power connection for driving a load.

In principle the pneumatic drive 2 could also be a piston rod-less linear drive. Instead of the piston rod 7 there would then be another force output member, as for example an entrainment dog extending through a longitudinal slot in the drive housing 4.

The pneumatic drive system 1 is suitable for any desired purpose. In a particularly advantageous fashion it may be employed in the smelting and/or processing of aluminum, the pneumatic drive 2 then constituting a so-called crust breaker cylinder. The following description is with respect to this application, but is also relevant for other applications.

In the case of use as a crust breaker cylinder the pneumatic drive 2 is, departing from the showing in the drawing, installed with a vertical alignment of its longitudinal axis and at a distance from the molten aluminum. The drive housing 4 is in this case fixed in a stationary manner on a frame and the piston rod 7 extends downward. With the output drive unit 6 retracted into the drive housing 4 to a maximum extent, this in the following being termed the “retracted end of stroke position” as indicated in chained lines in FIG. 1, the output drive unit 6 is completely withdrawn from the melt in an upward direction. A plunger element 14 arranged at the outer end of the piston rod 7 is in this case spaced from the surface of the melt (not illustrated). By controlled pressure actuation the output drive unit 6 may be driven to perform the extending movement 5a, it dipping into the metal melt after moving a certain distance, the plunger element 14 stabbing through any crust of material on the surface of the melt. The material crust is accordingly broken up. The output drive unit 6 then shifts as far as its end of stroke position, not illustrated in detail, opposite to its retracted end of stroke position. Both end of stroke positions are preferably preset owing to the output drive unit 6 striking an abutment face on the housing in a manner which is not depicted, such abutment face being more particularly provided on the end terminal wall 2a and 2b of the drive housing 4.

By reversing the action of the compressed air the extended output drive unit 6 can be driven to perform a radial working movement 5b, it being completely retracted upward out of the melt until it ultimately is located back in the retracted end of stroke position.

The pressure actuation causing the working movement 5a and 5b is set by a direction setting valve 11 of the control means 3. The latter is connected on the one hand with a compressed air source 15 providing the compressed air at the desired operational pressure and with the atmosphere 16. On the other hand it is connected by way of a first fluid control line 17 with the first working chamber 12 and by way of a second fluid control line 18 with the second working chamber 13. It can be selectively positioned in either of two switching positions, one working chamber 12 or 13 having compressed air supplied to it, whereas simultaneously the respectively other working chamber 13 or 12 is vented. The simplest way to provide this functionality is, as illustrated, to have a 5/2 way valve.

The actuation of the direction setting valve 11 is preferably implemented electrically or electromagnetically.

It may be a question of a directly operated valve or of a pilot valve. To design for the desired functionality use may be made of a combination of several functionally connected individual valves, for example one with two 3/2 direction setting or routing valves.

On the first control line 17 first control valve means 22 are placed. In a comparable fashion second control valve means 23 are arranged on the second control line 18. Both control valve means 22 and 23 can be selectively assume the open position 24 depicted in the drawing or a choked position 25 functioning inter alia as an air economy setting. Preferably the control valve means 22 and 23 are, respectively, designed as twin position valves and comprise a control valve member 26, only symbolically indicated, which defines either the open position 24 or the choked position 25 owing to its current setting.

Using loading means 27, more particularly in the form of spring means, the control valve means 22 and 23 are constantly urged toward the open position. The home position of the control valve means 22 and 23 is therefore the open position 24.

In the open position 24 the compressed air is provided with a maximum flow cross section. The latter is preferably so selected that the compressed air is not subjected to any choking effect, or at least not to any substantial choking effect, on flowing through the control valve means 22 and 23. The flow cross section then available may particularly be equal to the rated cross section of the respectively associated control lines 17 and 18.

In the choking setting 25 the compressed air has a free flow cross section for its passage into the connected working chamber 12 or 13. The flow cross section made available in the choking position 25 is nevertheless less than that in the open position so that the compressed air flowing through is choked. As long as compressed air is flowing through the control valve means 22 or 23 in their choking state into the respectively connected working chamber 12 or 13 there will be a lower air pressure at the outlet of the control valve means 22 and 23 than at the valve inlet of the direction setting valve 11. The input pressure will normally be equal to the operational pressure supplied by the compressed air source 15 if there is no choke point, serving for pressure reduction, between the compressed air source 15 and the control valve means 22 and 23 (not illustrated).

The flow cross section made available in the choking setting 25 will preferably be of such a size that in the choking setting 25, taking into account the air pressure obtaining at the control valve means 22 and 23, a flow rate will be set which is located in the range of the air loss occurring owing to leakage, such air leakage being allowable owing to tolerances in the system section downstream from the control valve means 22 and 23.

A certain degree of leakage is unavoidable owing to system leaks which cannot be sealed off. Small quantities of compressed air may be leaked out in particular at line connection points or in the dynamically sealed parts between the output drive unit 6 and the drive housing 4. If the choke point is upstream, in the connected working chamber 12 or 13 compressed air will in any case be replenished approximately in an amount equal to the loss owing to leakage at the same time. Even if this flow rate is not able to be exactly set, it should at least be in the range of the permissible leakage rate, it being possible to select an ideal value which involves a somewhat higher input flow rate than the leakage rate.

In order to render possible an exact user-specific adjustment the control valve means 22 and 23 may possess adjustment means 28, symbolically indicated by an arrow, which render possible an adjustable and in particular stepless setting of the flow cross section made available in the choked position 25.

For the two control valve means 22 and 23 respective actuating means 32 are provided, same rendering possible an activation of the control valve means 22 and 23, and preferably also a deactivation, dependent on the axial position of the output drive unit 6.

In the case of the particularly robust structure of the working example the actuating means 32 are designed for a mechanical actuation of the control valve means 22 and 23. They comprise response means 33, which are here in the form of a plunger member mounted for sliding in the longitudinal direction of the output drive unit 6 and starting at one respective one of the two terminal walls 2a and 2b extend axially into the internal space of the drive housing 4 and in a direction toward the drive piston 8.

The response means 33 are kinematically coupled with the control valve member 26 and therefore assume, in the home position of the control valve means 22 and 23, a response position extending into the internal space of the drive housing 4 axially as far as possible owing to the action of the actuation means 27 also belonging to the actuation means 32.

The output drive unit 6 approaching an end of stroke position moves so that its drive piston 8 strikes, before reaching the end of stroke position, the response means 33 in their response position. In this case such response means 33 belong, like the associated actuation means 32, to those control valve means 22 and 23, which are responsible for the supply of compressed air to the respective working chamber 12 and 13, which is on the far side. In other words the output drive unit 6 cooperates in the vicinity of the retracted end of stroke position, with those actuation means 32, which are associated with the second control valve means 23 responsible for the supply of compressed air to the second working chamber 13. In the extended end of stroke position the output drive unit 6 cooperates with the first control valve means 22 responsible for the supply to the first working chamber 12.

The arrangement is such that the output drive unit 6 only acts on the response means 33 when it has reached a certain distance “S” short of the associated end of stroke position. When it has covered this remaining distance “S”, which practically defines the response range of the response means 33, the response means 33 are drawn back by the output drive unit 6, something which in the case of simultaneous compression of the resilient actuation means 27 causes a switch over of the associated actuation means 22 or 23 from the so far assumed open position into the choked position.

If the direction of motion of the output drive unit 6 is then reversed, the control valve means 22 or 23 previously in the choked setting will be switched back by the actuation means 27 belonging to the actuation means 32 into the open position. The response means 33 practically follow the repelling output drive unit 6 until it is back in the initial response position.

A typical working cycle of the pneumatic drive system 1 of the example takes place as follows.

The starting point is the retracted end of stroke position indicated in chained lines of the output drive unit. Here the second control valve means 23 will be in the choked position owing to the activated actuating means 32, whereas the first control valve means 22 assume the open position.

In order now to cause the extending working movement or stroke compressed air is let in through the direction setting valve 11 (which is in the switching position as illustrated) into the first control line 17, while simultaneously the second control line 18 is vented.

Initially the extension speed of the output drive unit 6 is in this case still somewhat reduced, because the compressed air can only leave the second working chamber 13 with a choking effect. However as soon as the output drive unit 6 has left the effective range of the response means 33 associated with the second control valve means 23, the full discharge flow cross section will be available, which is defined by the open setting of the second control valve means 23. The output drive unit 6 will now be smartly shifted at a high speed toward its extended end of stroke position, it being in a position to hack through any crust on a metallic melt.

Just short of reaching the extended end of stroke position the output drive unit 6 will cooperate with the actuating means 32 of the first control valve means 32 and will switch same & into the choked setting 25 so that the time related rate of output flow of the compressed air will be further reduced.

Following this by actuation, which is for example time or position dependent, the direction setting valve 11 will switched over into the second switching position. There will be then be the same course of action as described above although however the output drive unit 6 will perform the retracting movement 5b and will clear the melt again. As soon as the output drive unit 6 then strikes the response means 33 of the second control valve means 23 the switch over in the latter into the choked setting will commence so that the air current flowing into the second working chamber 13 will be reduced.

Owing to the above explained dimensions of the flow cross section opened in the choked setting 25 compressed air in the second working chamber 13 will be continuously replenished at least to a such degree that leakage occurring is made good. Accordingly the output drive unit 6 will normally remain motionless in the retracted end of stroke position. The system as a whole is thus at rest and free of mechanical loads.

A new working cycle of action will commence with renewed switching over of the direction setting valve 11.

If in the course of service of the pneumatic drive system 1 there is substantial wear which leads to an increase in the leak rate, the replenishing compressed air supplied in the choked setting 25 will be no longer be sufficient to hold the output drive unit 6 in the retracted end of stroke position. More particularly in the case of a vertical location the output drive unit 6 will consequently have a tendency to drift out of the retracted end of stroke position. However as soon as it has cleared the response range of the response means 33—this being the case in the embodiment—and when the output drive unit 6 has shifted through the distance “IS” out of the retracted end of stroke position, temporary switching over of the second control valve means 23 in the open position 24 will cause a higher rate of replenishment of compressed air into the second working chamber 13 until the output drive unit 6 is back in the retracted end of stroke position again and the second control valve means 23 are back in the choked position 25.

This jabbing movement, able to be seen by eye, with a shorter stroke of the output drive unit 6 functions as an indication of wear of the output drive unit 6. It is an expression of a system leak larger than that allowed and a sign of wear of one or more components of the system. There is thus the possibility promptly replacing and of ensuring reliable operation of the drive system 1 at all times.

The indication of wear as described naturally functions as regards the first control valve means 22 as well, when the output drive unit 6 is subjected in the extended end of stroke position to an opposite force acting in the retraction direction, for example when the pneumatic drive 2 is employed with an alignment other than the described one.

Instead of mechanical response means 33 response means operating without making physical contact could be utilized, more particularly with the use of so-called reed switches or other position sensors. In this case the switching over of the control valve means 22 and 23 would take place with implementation by electric signals.

In the working embodiment the control valve means 22 and 23 are collected together with the pneumatic drive 2 as a compact structural assembly. However if necessary the direction setting valve 11 may be included in this structural unit together with the control lines 17 and 18 present.

As a departure from the working example control valve means could also be present on only one of the two control lines 17 and 18. More particularly in the case of use as a crust breaking cylinder it would in principle be sufficient for the control valve means 23 in accordance with the invention to be associated with only the second control line 18 communicating with the second working chamber 13. The first control line 17 could in this case be a plain line without any valve means on it.

In lieu of having only one single pneumatic cylinder 2 several pneumatic drives could be included in the pneumatic drive system 1. Each pneumatic drive 2 would then be provided with its own control valve means 22 and 23. The direction setting valve 11 could then be employed for the control of a plurality of pneumatic drives 2.

1. A pneumatic drive system comprising at least one pneumatic drive possessing a drive housing and an output drive unit able to be shifted in relation to the drive housing by the action of compressed air, the output drive unit including an output drive piston, which in the drive housing separates two working chambers from one another, one or both of such working chambers being connected with a pneumatic control line, such control line having control valve means able to be switched over between an air economy position and an open position making available a flow cross section which is larger than that of the air economy position, wherein actuating means being associated to the control valve means and able to be activated in a manner dependent on the position of the output drive unit, such actuating means being able to cause a switching over of the control valve means into the air economy position when the output drive unit, owing to the compressed air flowing through the control valve means into the pneumatic drive, has reached an end of stroke position or a position just short thereof, wherein the air economy position is in the form of a choking position opening up a flow cross section which is smaller than that of the open position.

2. The drive system as set forth in claim 1, wherein the at least one pneumatic drive is a linear drive.

3. The drive system as set forth in claim 1, wherein the at least one pneumatic drive is a pneumatic cylinder whose output drive unit includes a piston rod extending from the drive housing at the end thereof.

4. The drive system as set forth in claim 3, wherein the pneumatic cylinder is a crust breaker cylinder on whose piston rod at the end a suitable jabbing element is provided for jabbing through the crust on molten metal.

5. The drive system as set forth in claim 1, wherein, on the input side of the control valve means, there is provided a direction setting valve connected or able to be connected with a source of compressed air, such direction setting valve of supplying the two control lines alternatingly in opposite succession with compressed air subject an operating pressure or to vent such lines.

6. The drive system as set forth in claim 5, wherein the direction setting valve is in the form of a 5/2 way valve.

7. The drive system as set forth in claim 1, wherein at least the control valve means and the pneumatic drive are collected together as a single structural assembly.

8. The drive system as set forth in claim 1, wherein the actuating means include response means adapted to respond from or at a certain position of the output drive unit and so cause the switching over of the associated control valve means into the chokeing position.

9. The drive system as set forth in claim 8, further comprising actuating means designed to cause a mechanical switching of the control valve means, the response means of such actuating means extending into the path of motion of the output drive unit and being able to be shifted by same.

10. The drive system as set forth in claim 9, wherein the mechanical response means include at least one plunger member which is supported in a slideable manner.

11. The drive system as set forth in claim 8, wherein the actuating means are so designed that they switch back the associated control valve means into the open position when the output drive unit leaves the response range of the response means.

12. The drive system as set forth in claim 1, wherein the flow cross section available in the choking position represents a measure which by taking into account the air pressure present on the input side of the control valve means is setting a flow rate which lies in the range of the permissible leak rate occurring in the system section downstream from the control valve means and which preferably is equal to at least the level of this permissible leak flow rate.

13. The drive system as set forth in claim 1, wherein the control valve means possess adjustment means for producing an adjustable setting of the flow cross section provided in the choking position.
